(19) United States
(12) Patent Application Publication
(10) Pub. No.: US 2020/0338780 A1
(43) Pub. Date: Oct. 29, 2020

(54) CHAIN SAW

(71) Applicant: MAKITA CORPORATION, Anjo-shi (JP)

(72) Inventors: Yoshifumi Watanabe, Anjo-shi (JP); Junichi Masuda, Anjo-shi (JP); Hideki Kachi, Anjo-shi (JP); Tsunahisa Nakamura, Anjo-shi (JP)

(73) Assignee: MAKITA CORPORATION, Anjo-shi (JP)

(21) Appl. No.: 16/854,249

(22) Filed: Apr. 21, 2020

(30) Foreign Application Priority Data
Apr. 23, 2019 (JP) 2019-082169
Apr. 23, 2019 (JP) 2019-082174

(51) Int. Cl. B27B 17/08; B27B 17/12

(52) U.S. Cl. CPC B27B 17/083; B27B 17/02; B27B 17/12

(57) ABSTRACT

A chain saw may comprise a braking mechanism; a housing including a first space and a second space in which the braking mechanism is disposed; and an operation member. The housing may include a through hole communicating the second space to outside of the housing. The operation member may be disposed over the second space and the outside of the housing through the through hole. The operation member may be movable between a braking position where the operation member causes the braking mechanism to interrupt rotation of a saw chain and a driving position where the operation member causes the braking mechanism not to interrupt the rotation of the saw chain. The braking mechanism may comprise a connecting member that moves in the second space in conjunction with movement of the operation member. The housing may include an opening communicating the first space to the second space.

### CROSS-REFERENCE TO RELATED APPLICATION

This application claims priority to Japanese Patent Application No. 2019-082169, filed on Apr. 23, 2019 and Japanese Patent Application No. 2019-082174, filed on Apr. 23, 2019, the entire contents of which are hereby incorporated by reference into the present application.

### TECHNICAL FIELD

The disclosure herewith relates to a chain saw.

### BACKGROUND

Japanese Patent Application Publication No. 2016-101626 describes a chain saw. The chain saw comprises a prime mover configured to rotate a saw chain, a braking mechanism configured top rotation of the saw chain, a housing including a first space in which the prime mover is disposed and a second space in which the braking mechanism is disposed, and an operation member configured to operate the braking mechanism. The housing includes a through hole communicating the second space to outside of the housing. The operation member is disposed over the second space and the outside of the housing through the through hole. The operation member is movable between a braking position where the operation member causes the braking mechanism to interrupt the rotation of the saw chain and a driving position where the operation member causes the braking mechanism not to interrupt the rotation of the saw chain. The braking mechanism comprises a connecting member configured to move in the second space in conjunction with movement of the operation member.

Japanese Patent Application Publication No. 2015-140014 describes a chain saw. The chain saw comprises a motor configured to rotate a saw chain, an oil tank storing oil to be supplied to the saw chain, and a housing including a first space in which the motor and the oil tank are disposed. The housing includes a through hole communicating the first space to outside of the housing. The oil tank comprises an oil tank body storing the oil therein, an oil filler part that is inserted in the through hole and is exposed to the outside of the housing and through which the oil is supplied into the oil tank body.

### SUMMARY

In the chain saw as described above, the through hole is designed to be slightly larger than a cross section of the operation member. Due to this, debris, which is generated by the chain saw cutting an object such as wood, may pass through the through hole and enter the second space. Accumulation of such debris in the second space may cause trouble in the operation of the braking mechanism. The disclosure herein provides a technique that is capable of preventing trouble in an operation of braking mechanism, which is caused by accumulation of debris in a housing.

Further, in the chain saw as described above, the oil may be spilled near the oil filler part during the oil supply to the oil tank. In the chain saw in which the oil filler part is exposed to the outside of the housing, the spilled oil flows along an outer surface of the oil tank and then flows into the housing from a gap between the oil filler part of the oil tank and the through hole of the housing. If the oil flows on a motor-side outer surface of the oil tank and flows into the housing, debris such as wood debris that enters the housing adheres to the motor-side outer surface of the oil tank. When this happens, debris entering the housing further accumulates on the debris adhering to the oil tank. The accumulation of debris interrupts a flow of air for cooling the motor. The disclosure herein provides another technique that suppresses oil from flowing along a motor-side outer surface of an oil tank.

The disclosure herein discloses a chain saw. The chain saw may comprise: a prime mover configured to rotate a saw chain; a braking mechanism configured to stop rotation of the saw chain; a housing including a first space in which the prime mover is disposed and a second space in which the braking mechanism is disposed; and an operation member configured to operate the braking mechanism. The housing may include an opening communicating the first space to the second space and a through hole communicating the second space to outside of the housing. The operation member may be disposed over the second space and the outside of the housing through the through hole. The operation member may be movable between a braking position where the operation member causes the braking mechanism to interrupt the rotation of the saw chain and a driving position where the operation member causes the braking mechanism not to interrupt the rotation of the saw chain. The braking mechanism may comprise a connecting member configured to move in the second space in conjunction with movement of the operation member.

In the above configuration, the opening communicates the first space in which the prime mover is disposed to the second space in which the braking mechanism is disposed. This allows debris in the second space to be discharged to the first space through the opening when the connecting member of the braking mechanism moves in the second space. As such, it is possible to suppress trouble in the operation of the braking mechanism which is caused by accumulation of debris in the second space.

The disclosure herein discloses another chain saw. The chain saw may comprise: a motor configured to rotate a saw chain; an oil tank storing oil to be supplied to the saw chain; and a housing including a first space in which the motor and the oil tank are disposed. The housing may include a through hole communicating the first space to outside of the housing. The oil tank may comprise: an oil tank body storing the oil therein; an oil filler part that is exposed to the outside of the housing through the through hole and through which the oil is supplied into the oil tank body; and a suppression structure. The suppression structure may be disposed on a motor side relative to the oil filler part. When the chain saw is placed on a plane such that the oil filler part faces upward, the suppression structure may suppress the oil on a first outer surface of the oil tank body that faces upward from flowing to the motor side.

In the above-described configuration, the suppression structure is disposed on the motor side relative to the oil filler part. Therefore, when the oil is spilled near the oil filler part toward the motor side, the suppression structure suppresses the spilled oil from flowing to the motor side. As a result, it is possible to suppress the oil from flowing on a motor-side outer surface of the oil tank that is located in the housing.

### BRIEF DESCRIPTION OF DRAWINGS

FIG. 1 is a perspective view of a chain saw of an embodiment, viewing the chain saw from left rear side.

FIG. 2 is a longitudinal cross-sectional view of the chain saw of the embodiment.

FIG. 3 is a longitudinal cross-sectional view of the chain saw of the embodiment in a state where the chain saw is placed on a plane such that an oil filler part of an oil tank of the chain saw faces upward.

FIG. 4 is a perspective view of the oil tank of the chain saw of the embodiment.

FIG. 5 is a diagram showing a positional relationship between an inner wall of the chain saw and a communication hole according to the embodiment.

FIG. 6 is a perspective view of the chain saw of the embodiment, viewing the chain saw from right front side.

FIG. 7 is a right side view of the chain saw of the embodiment in which an operation member is in a driving position and a sprocket cover, a guide bar, and a brake cover of the chain saw are removed.

FIG. 8 is the right side view of the chain saw of the embodiment in which the operation member is in a braking position and the sprocket cover, the guide bar, and the brake cover of the chain saw are removed.

FIG. 9 is a diagram showing a positional relationship between a switch member and a plate member when the operation member of the chain saw of the embodiment is in the driving position.

FIG. 10 is a diagram showing a positional relationship between the switch member and the plate member when the operation member of the chain saw of the embodiment is in the braking position.

FIG. 11 is a diagram showing a positional relationship between an outer plate, the guide bar, and an inner plate of the chain saw of the embodiment.

FIG. 12 is a perspective view of the inner plate of the chain saw of the embodiment.

FIG. 13 is a perspective view of the outer plate of the chain saw of the embodiment.

### DETAILED DESCRIPTION

Representative, non-limiting examples of the present invention will now be described in further detail with reference to the attached drawings. This detailed description is merely intended to teach a person of skill in the art further details for practicing preferred aspects of the present teachings and is not intended to limit the scope of the invention. Furthermore, each of the additional features and teachings disclosed below may be utilized separately or in conjunction with other features and teachings to provide improved chain saws, as well as methods for using and manufacturing the same.

Moreover, combinations of features and steps disclosed in the following detailed description may not be necessary to practice the invention in the broadest sense, and are instead taught merely to particularly describe representative examples of the invention. Furthermore, various features of the above-described and below-described representative examples, as well as the various independent and dependent claims, may be combined in ways that are not specifically and explicitly enumerated in order to provide additional useful embodiments of the present teachings.

All features disclosed in the description and/or the claims are intended to be disclosed separately and independently from each other for the purpose of original written disclosure, as well as for the purpose of restricting the claimed subject matter, independent of the compositions of the features in the embodiments and/or the claims. In addition, all value ranges or indications of groups of entities are intended to disclose every possible intermediate value or intermediate entity for the purpose of original written disclosure, as well as for the purpose of restricting the claimed subject matter.

In one or more embodiments, a chain saw may comprise: a prime mover configured to rotate a saw chain; a braking mechanism configured to stop rotation of the saw chain; a housing including a first space in which the prime mover is disposed and a second space in which the braking mechanism is disposed; and an operation member configured to operate the braking mechanism. The housing may include an opening communicating the first space to the second space and a through hole communicating the second space to outside of the housing. The operation member may be disposed over the second space and the outside of the housing through the through hole. The operation member may be movable between a braking position where the operation member causes the braking mechanism to interrupt the rotation of the saw chain and a driving position where the operation member causes the braking mechanism not to interrupt the rotation of the saw chain. The braking mechanism may comprise a connecting member configured to move in the second space in conjunction with movement of the operation member.

In the above configuration, the opening communicates the first space in which the prime mover is disposed to the second space in which the braking mechanism is disposed. This allows debris in the second space to be discharged to the first space through the opening when the connecting member of the braking mechanism moves in the second space. As such, it is possible to suppress trouble in operation of the braking mechanism which is caused by accumulation of debris in the second space.

In one or more embodiments, when the chain saw is in an operating posture, the opening may be disposed below the connecting member in a vertical direction.

In the above configuration, when the chain saw is in the operating posture, debris in the second space accumulates near the opening by gravity. Therefore, when the connecting member moves in the second space, the debris in the second space can be easily discharged from the second space to the first space through the opening.

In one or more embodiments, the connecting member may comprise: a joint member that is in a linear shape when the operation member is in the driving position and is in a bent shape when the operation member is in the braking position; and a bias member configured to apply a compression force to the joint member.

In the above configuration, the joint member is maintained in the linear shape even when the bias member applies the compression force in a state where the operation member is in the driving position and the joint member is in the linear shape. However, when the chain saw undergoes a kickback impact during a cutting process, the joint member is slightly bent and the compression force applied by the bias member causes the joint member to switch to the bent shape from the linear shape. The above configuration can automatically activate the braking mechanism when the kickback occurs, and thus can improve operator's safety.

In one or more embodiments, the chain saw may further comprise: a shaft configured to transmit rotation of the prime mover to the saw chain; and a brake drum fixed to the shaft. The braking mechanism may further comprise a band shoe disposed to surround an outer periphery of the brake drum. The band shoe may be configured to shrink a diameter of the band shoe to interrupt rotation of the brake drum when the operation member moves from the driving position to the braking position and may be configured to expand the diameter of the band shoe not to interrupt the rotation of the brake drum when the operation member moves from the braking position to the driving position.

In the above configuration, the braking mechanism can be realized by a simple configuration.

In one or more embodiments, a chain saw may comprise: a motor configured to rotate a saw chain; an oil tank storing oil to be supplied to the saw chain; and a housing including a first space in which the motor and the oil tank are disposed. The housing may include a through hole communicating the first space to outside of the housing. The oil tank may comprise: an oil tank body storing the oil therein; an oil filler part that is exposed to the outside of the housing through the through hole and through which oil is supplied into the oil tank body; and a suppression structure. The suppression structure may be disposed on a motor side relative to the oil filler part. When the chain saw is placed on a plane such that the oil filler part faces upward, the suppression structure may suppress the oil on a first outer surface of the oil tank body that faces upward from flowing to the motor side.

In the above configuration, when the oil is spilled near the oil filler part toward the motor side, the suppression structure suppresses the spilled oil from flowing to the motor side. Therefore, it is possible to suppress the oil from flowing on a motor-side outer surface of the oil tank that is located in the housing.

In one or more embodiments, when the chain saw is placed on the plane such that the oil filler part faces upward, the first outer surface of the oil tank body is inclined downward in a direction away from the motor.

In the above configuration, when the oil is spilled near the oil filler part, the spilled oil flows on the first outer surface of the oil tank body in the direction away from the motor. Therefore, it is possible to suppress the oil from flowing on the motor-side outer surface of the oil tank that is located in the housing.

In one or more embodiments, the oil tank may further comprise a guide structure. The guide structure may be connected to the suppression structure and may be configured to guide the oil in a direction away from the motor when the chain saw is placed on the plane such that the oil filler part faces upward.

In the above configuration, the oil spilled near the oil filler part and held back by the suppression structure is guided by the guide structure and flows in the direction away from the motor. As a result, it is possible to suppress the oil from flowing on the motor-side outer surface of the oil tank that is located in the housing.

In one or more embodiments, a receiver part may be disposed on a first-space-side surface of the housing. The receiver part may be configured to receive the oil dropped from the oil tank. The receiver part may be disposed below the oil tank when the chain saw is in an operating posture and may at least partially overlap the oil tank when the chain saw is viewed from above.

When the chain saw is in the operating posture, the spilled oil flows downward along the outer surface of the oil tank, and then drops from the oil tank. In the above configuration, the oil drops into the receiver part disposed on the first-space-side surface of the housing. As such, it is possible to suppress the oil from dropping out of the receiver part.

In one or more embodiments, a communication hole may be disposed in the housing. The communication hole may communicate the first space to the outside of the housing. The communication hole may be disposed at the receiver part.

In the above configuration, when the chain saw is in the operating posture, the oil in the receiver part is discharged to the outside of the housing through the communication hole. As such, accumulation of the oil in the housing can be suppressed.

In one or more embodiments, the first space may comprise an air passage through which air for cooling the motor flows. The oil tank may define a part of the air passage.

In the above configuration, air flows along the outer surface of the oil tank. Even when debris adheres to the outer surface of the oil tank, the air can remove the debris from the outer surface of the oil tank.

### Embodiment

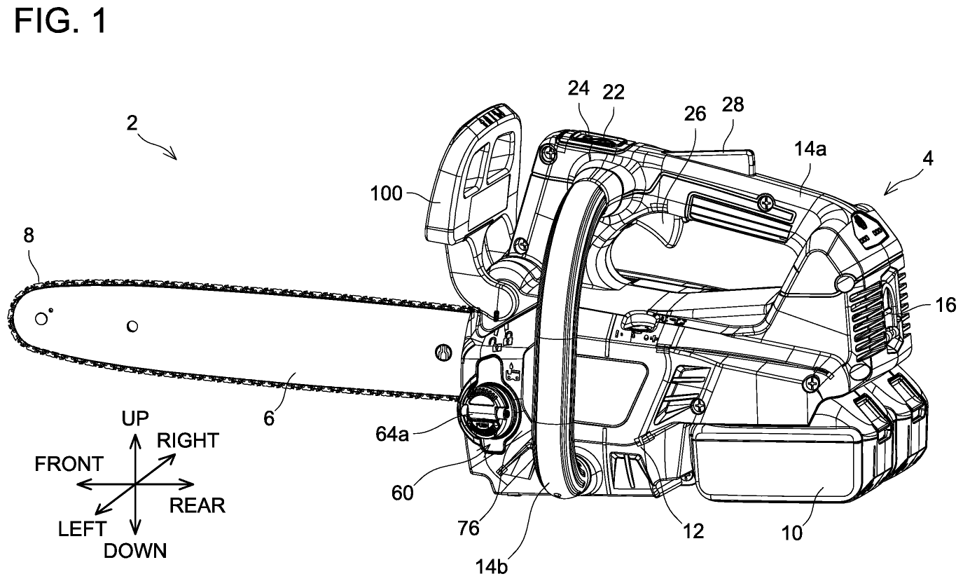

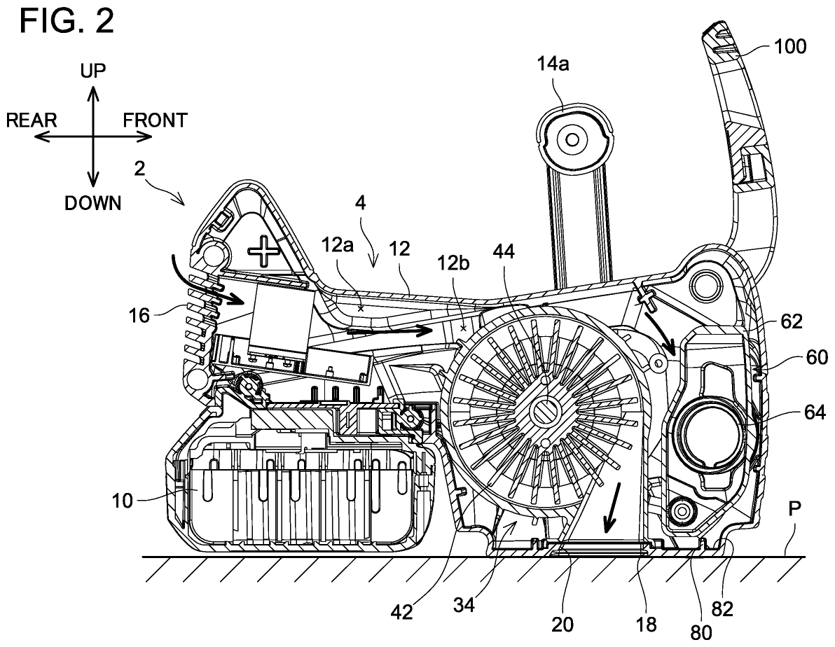

With reference to FIGS. 1 to 13, a chain saw 2 of an embodiment will be described. As shown in FIG. 1, the chain saw 2 comprises a housing 4, a guide bar 6, and a saw chain 8. The guide bar 6 is an elongated plate-shape member. The guide bar 6 is attached to the housing 4 to project forward from the housing 4. The saw chain 8 is an annular chain in which a plurality of cutters is connected to each other. The saw chain 8 is attached along the periphery of the guide bar 6. A battery 10 is attached to the housing 4. The chain saw 2 rotates the saw chain 8 along the periphery of the guide bar 6 by electric power supplied from the battery 10 to cut an object such as wood. Hereinafter, when the chain saw 2 is placed on a plane P (see FIG. 2) such as the ground, a direction orthogonal to the plane P (vertical direction) is termed an up-down direction, a longitudinal direction of the guide bar 6 projected onto the plane P will be termed a front-rear direction, and a direction orthogonal to both the up-down direction and the front-rear direction will be termed a left-right direction. In order to facilitate understanding of the drawings, the drawings other than FIG. 1 omit the depiction of the saw chain 8.

The housing 4 comprises a housing body 12. The battery 10 is attached to a rear lower portion of the housing body 12. A power lamp 24 and a power switch 22 with which an operator can switch the chain saw 2 on and off are disposed on an upper surface of the housing body 12. When the power lamp 24 is on, the chain saw 2 is on, whereas when the power lamp 24 is off, the chain saw 2 is off.

The chain saw 2 is a top-handle chain saw. A top handle 14a configured to be gripped by the operator is disposed at an upper portion of the housing body 12. The top handle 14a is disposed rearward relative to the power switch 22 and the power lamp 24. The cross section of the top handle 14a has a substantially circular shape. A trigger switch 26 is disposed on a lower surface of the top handle 14a. When the trigger switch 26 is pushed up by the operator, the saw chain 8 rotates along the periphery of the guide bar 6.

A trigger lock lever 28 is disposed on an upper surface of the top handle 14a. In a state where the trigger lock lever 28 is pushed up, the operator cannot operate the trigger switch 26. On the other hand, in a state where the trigger lock lever 28 is pushed down, the operator can operate the trigger switch 26.

Aside handle 14b is a member configured for the operator to grip by hand. The side handle 14b connects a front upper portion of a left side surface of the housing body 12 with a front lower portion of the left side surface of the housing body 12. When using the chain saw 2, the operator grips the top handle 14a with the right hand and grips the side handle 14b with the left hand to hold the chain saw 2.

As shown in FIG. 2, the housing body 12 includes an air intake hole 16 in a rear surface of the housing body 12. The air intake hole 16 penetrates the housing body 12 in a thickness direction of the housing body 12. The air intake hole 16 is a hole for drawing air from the outside of the housing body 12 into the inside thereof.

The housing body 12 includes a recess 18 in a lower surface of the housing body 12. The recess 18 is recessed inward from the lower surface of the housing body 12. An air discharging hole 20 is disposed inside the recess 18. The air discharging hole 20 penetrates the housing body 12 in the thickness direction. The air discharging hole 20 is a hole for discharging air from the inside of the housing body 12 to the outside thereof. Even when the chain saw 2 is placed on the plane P in its operating posture, the air discharging hole 20 is not closed by the plane P.

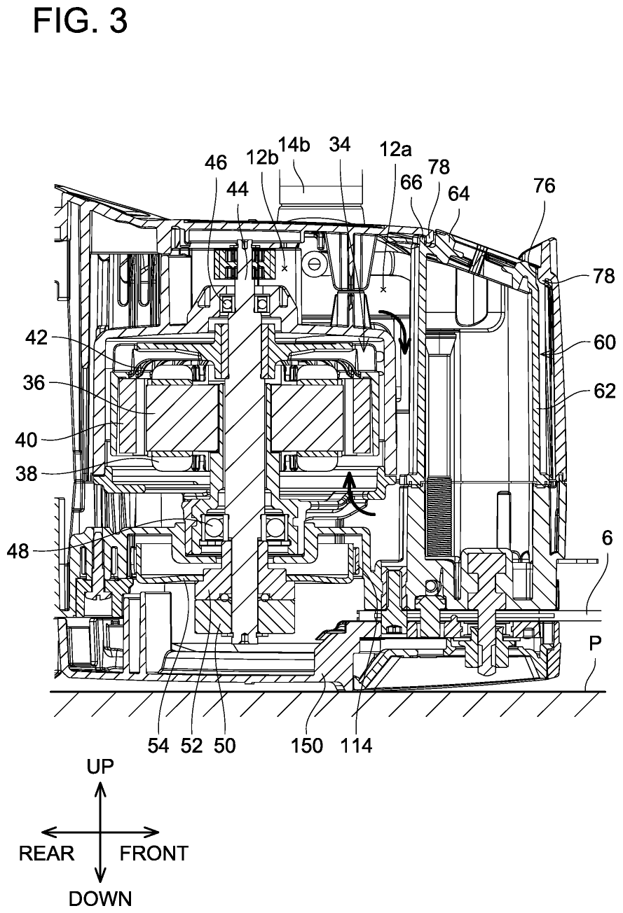

The housing body 12 includes a first space 12a therein. As shown in FIG. 3, a motor 34 and an oil tank 60 are disposed in the first space 12a.

The motor 34 is a prime mover configured to rotate the saw chain 8. The motor 34 is an outer-rotor DC brushless motor. The motor 34 includes a stator 36, a rotor 40, a cooling fan 42, and a shaft 44. The stator 36 is a member in which a coil wire 38 is wound around a core. The stator 36 is fixed to the housing body 12.

The rotor 40 is disposed outside the stator 36. When the electric power is supplied from the battery 10 to the coil wire 38, the rotor 40 rotates around the stator 36.

The cooling fan 42 is connected to the rotor 40. The cooling fan 42 rotates simultaneously with the rotation of the rotor 40. Air outside the housing 4 is thereby drawn into the first space 12a through the air intake hole 16 of the housing body 12. This air cools the stator 36, the rotor 40, and the shaft 44, and flows to the cooling fan 42. Then, the air is discharged from the air discharging hole 20 of the housing body 12 to the outside of the housing 4. FIG. 2 and FIG. 3 illustrate arrows indicating directions of the flow of air. Hereinafter, a part of the first space 12a through which the air flows by the rotation of the cooling fan 42 will be termed an air passage 12b.

The shaft 44 is disposed to penetrate the centers of the stator 36 and the rotor 40. The shaft 44 has an elongated cylindrical shape. The shaft 44 is rotatably supported by the housing body 12 via bearings 46 and 48. The shaft 44 is connected to the cooling fan 42. When the cooling fan 42 rotates with the rotation of the rotor 40, the shaft 44 also rotates simultaneously. The shaft 44 transmits the rotation of the motor 34 to the saw chain 8.

One end of the shaft 44 protrudes to the outside of the housing body 12. A sprocket 50 and a brake base 52 are fixed near the one end of the shaft 44. The sprocket 50 and the brake base 52 are disposed closer to the one end of the shaft 44 than the bearings 46, 48. A brake drum 54 is fitted to the brake base 52.

The sprocket 50 is disposed outside the housing body 12. The saw chain 8 extends from the guide bar 6 to the sprocket 50 and is hung thereover. When the motor 34 is driven, the sprocket 50 simultaneously rotates with the rotation of the shaft 44, and the saw chain 8 thereby rotates along the periphery of the guide bar 6.

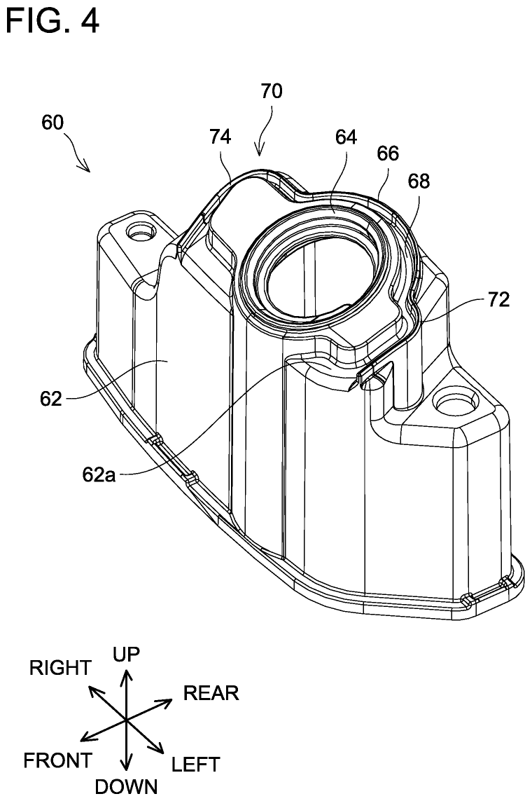

The oil tank 60 is disposed in front of the motor 34. In the first space 12a, the oil tank 60 is located at the foremost portion of the housing body 12. As shown in FIGS. 3 and 4, the oil tank 60 comprises an oil tank body 62, an oil filler part 64, a suppression structure 66, and a guide structure 70. In FIGS. 3 and 4, the oil filler part 64 of the oil tank 60 faces upward. Hereinafter, description will proceed with reference to the drawings in which the oil filler part 64 faces upward. Therefore, it should be noted that in the following description, the up-down direction, the front-rear direction, and the left-right direction will refer to directions when the oil filler part 64 faces upward.

As shown in FIG. 3, one end of the oil tank body 62 is fixed to the housing body 12. The oil tank body 62 and the housing body 12 define an inner space, and oil is stored in this space. The oil tank body 62 can store oil in the inner space. This oil is supplied to the saw chain 8 by an oil supply pump (not shown) that is activated in conjunction with the rotation of the motor 34. Since the oil reduces the frictional resistance between the saw chain 8 and the guide bar 6, wear of the saw chain 8 is suppressed. An outer surface of the oil tank body 62 defines a part of the air passage 12b. Air flows between the oil tank body 62 and the motor 34 along the outer surface of the oil tank body 62.

The oil filler part 64 is an opening through which the oil is supplied into the oil tank body 62. As shown in FIG. 4, the oil filler part 64 is disposed in a first outer surface 62a of the oil tank body 62. The first outer surface 62a corresponds to an upper surface of the oil tank 60 when the chain saw 2 is placed on the plane P such that the oil filler part 64 faces upward. The first outer surface 62a is inclined downward in a direction away from the motor 34 (i.e., toward the front of the chain saw 2).

As shown in FIG. 3, the oil filler part 64 is inserted in a through hole 76 formed in the housing body 12. When the chain saw 2 is in the operating posture as shown in FIG. 1, the through hole 76 is located at a front portion of the left side surface of the housing body 12. The through hole 76 penetrates the housing body 12 in the thickness direction. The through hole 76 communicates the first space 12a to the outside of the housing 4. Thus, the oil filler part 64 is exposed to the outside of the housing body 12. A removable cap 64a is attached to the oil filler part 64.

As shown in FIG. 4, the first outer surface 62a of the oil tank body 62 is provided with the suppression structure 66. The suppression structure 66 extends outward (i.e., upward) from the first outer surface 62a of the oil tank body 62. The suppression structure 66 extends along an outer periphery of the oil filler part 64. A groove 68 is formed between the oil filler part 64 and the suppression structure 66. The suppression structure 66 suppresses the oil on the first outer surface 62a from flowing toward the motor 34. This suppresses adhesion of the oil to a motor 34-side outer surface of the oil tank body 62, and thus accumulation of debris generated from a cut object can be suppressed in the air passage 12b.

In the state where the oil tank 60 is disposed in the first space 12a as shown in FIG. 3, the suppression structure 66 is disposed around a peripheral wall 78 that extends from an inner surface of the housing body 12 around the periphery of the through hole 76 (hereinafter referred to as the inner surface). The peripheral wall 78 is disposed between the oil filler part 64 and the suppression structure 66. That is, the oil filler part 64, the peripheral wall 78, and the suppression structure 66 are arranged in this order toward the motor 34. The peripheral wall 78 is disposed in the groove 68. The groove 68 receives the peripheral wall 78 therein.

As shown in FIG. 4, the guide structure 70 is disposed on the first outer surface 62a of the oil tank body 62. The guide structure 70 extends outward (i.e., upward) from the first outer surface 62a of the oil tank body 62. The guide structure 70 is connected to the suppression structure 66. The guide structure 70 and the suppression structure 66 are integrally formed. The guide structure 70 guides the oil on the first outer surface 62a in the direction away from the motor 34. The guide structure 70 comprises a first guide structure 72 and a second guide structure 74. The first guide structure 72 is disposed on the left side of the suppression structure 66 (below the suppression structure 66 when the chain saw 2 is in the operating posture), and the second guide structure 74 is disposed on the right side of the suppression structure 66 (above the suppression structure 66 when the chain saw 2 is in the operating posture). The first guide structure 72 extends leftward from its end connected to the suppression structure 66 and then curves forward. The second guide structure 74 extends rightward from its end connected to the suppression structure 66 and then curves forward. In the state where the oil tank 60 is disposed in the first space 12a, the first guide structure 72 and the second guide structure 74 are disposed around the peripheral wall 78 of the housing body 12, although this is not shown.

In the above, the description has proceeded referring to the drawings in which the oil filler part 64 faces upward. Hereinafter, however, the description will proceed referring to the drawings in which the chain saw 2 is in the operating posture. Therefore, in the following description, it should be noted that the up-down direction, the front-rear direction, and the left-right direction will refer to directions when the chain saw 2 is in the operating posture. As shown in FIG. 2, an inner wall 80 is disposed below the oil tank 60. The inner wall 80 is disposed on the inner surface of the housing body 12. The inner wall 80 extends from the inner surface of the housing body 12 toward the oil tank 60. The inner wall 80 extends in the left-right direction (i.e., in the direction perpendicular to the sheet of drawing in FIG. 2). One end of the inner wall 80 extends up to a left inner surface of the housing body 12. The inner wall 80 is separated from the oil tank 60.

The inner wall 80 defines a receiver part 82 in front of the inner wall 80. The receiver part 82 is formed on a lower inner surface of the housing body 12. The receiver part 82 is disposed between a front inner surface of the housing body 12 and the inner wall 80. The receiver part 82 extends in the left-right direction (i.e., in the direction perpendicular to the sheet of drawing in FIG. 2). The receiver part 82 is disposed below the oil tank 60. When the chain saw 2 in the operating posture is viewed from above, the receiver part 82 overlaps the oil tank 60. The receiver part 82 receives the oil dropped from the oil tank 60.

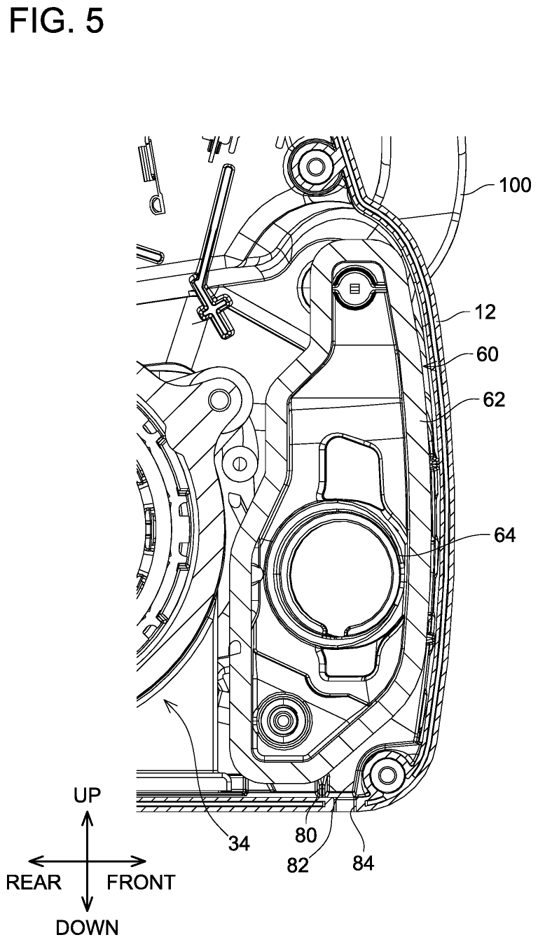

As shown in FIG. 5, the housing body 12 includes a communication hole 84 in a front portion of the lower surface of the housing body 12. The communication hole 84 penetrates the housing body 12 in the thickness direction. The communication hole 84 communicates the first space 12a to the outside of the housing 4. The communication hole 84 is disposed at the receiver part 82. The communication hole 84 is located at a longitudinal end portion of the receiver part 82.

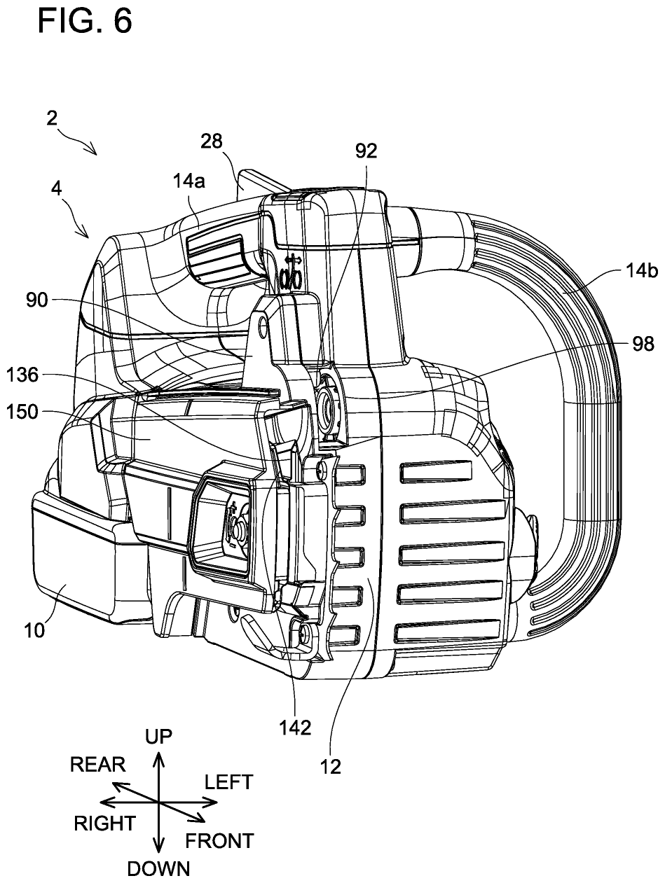

As shown in FIG. 6, the housing 4 further comprises a brake cover 90. FIG. 6 omits the depiction of the guide bar 6. The brake cover 90 is fixed to a right side surface of the housing body 12. The brake cover 90 defines a second space 92 between the brake cover 90 and the housing body 12. That is, the housing 4 includes the second space 92. At the front, the brake cover 90 forms a through hole 98 between the brake cover 90 and the housing body 12. That is, the housing 4 includes the through hole 98. The through hole 98 communicates the second space 92 to the outside of the housing 4.

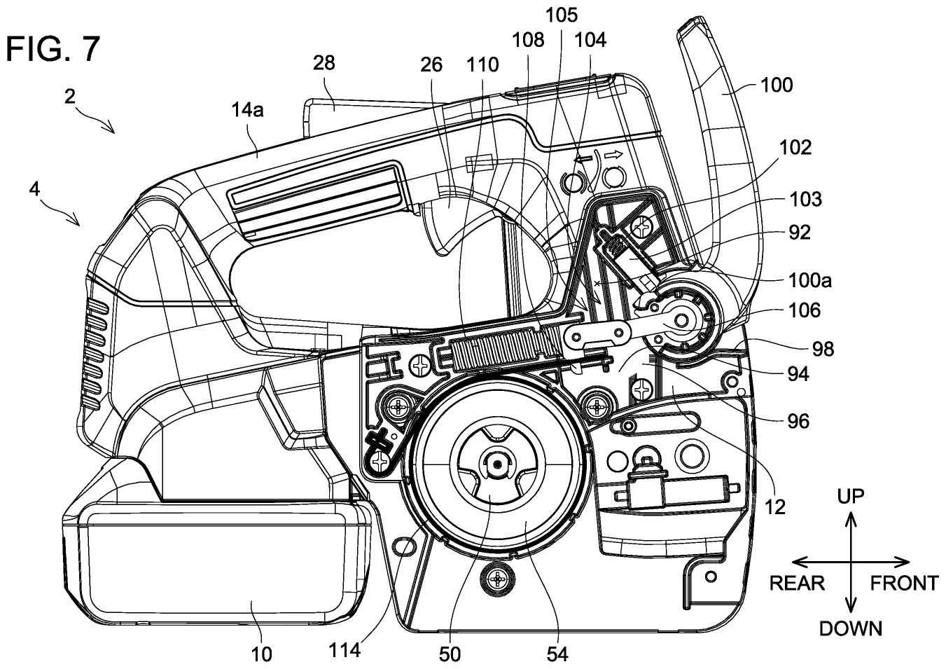

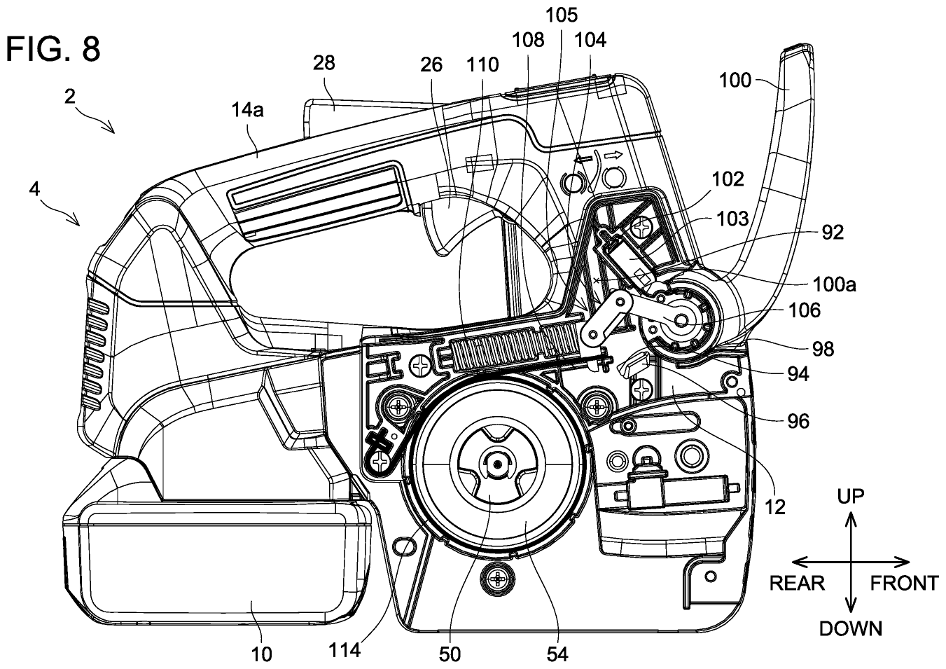

The brake cover 90 covers both an opening 94 (see FIGS. 7 and 8) formed in the housing body 12 and a guide wall 96 (see FIGS. 7 and 8) disposed on the housing body 12.

As shown in FIGS. 7 and 8, the opening 94 and the guide wall 96 are disposed at a front portion of the right side surface of the housing body 12. The opening 94 penetrates the housing body 12 in the thickness direction. The opening 94 communicates the air passage 12b (i.e., the first space 12a) to the second space 92.

The guide wall 96 is integrally formed with the housing body 12. The guide wall 96 protrudes from the right side surface of the housing body 12. The guide wall 96 extends along a lower edge of the opening 94. A base end of the guide wall 96 is connected to the right side surface of the housing body 12. The guide wall 96 extends more upward at its portions farther apart from the right side surface of the housing body 12. That is, the guide wall 96 is inclined upward from the base end to distal end of the guide wall 96. The guide wall 96 does not cover an upper edge of the opening 94.

The chain saw 2 further comprises an operation member 100 and a braking mechanism 104. A part of the operation member 100 and the braking mechanism 104 are disposed in the second space 92.

The operation member 100 is inserted in the through hole 98. The operation member 100 is disposed over the second space 92 and the outside of the housing 4. The cross section of the operation member 100 at its portion that is inserted in the through hole 98 is smaller than the cross section of the through hole 98. Therefore, even in a state where the operation member 100 is inserted in the through hole 98, the second space 92 and the outside of the housing 4 communicate to each other through the through hole 98. An end portion of the operation member 100 disposed on second space 92 side is rotatably supported by the housing body 12. The operation member 100 is movable between a driving position and a braking position. Pushing the operation member 100 in the driving position forward causes the operation member 100 to move from the driving position to the braking position. On the other hand, lifting the operation member 100 in the braking position rearward causes the operation member 100 to move from the braking position to the driving position.

The braking mechanism 104 is operated by the operation member 100 to stop the rotation of the saw chain 8. The braking mechanism 104 comprises a bias member 102, a projection member 103, a connecting member 105, and a band shoe 114. The bias member 102 is a coil spring. As shown in FIG. 7, when the operation member 100 is in the driving position, the bias member 102 presses the projection member 103 against a groove portion 100a which is located near the second space 92-side end portion of the operation member 100. Thereby, even when a force that pushes the operation member 100 forward acts on the operation member 100, the operation member 100 maintains in the driving position if the force is smaller than a predetermined value. On the other hand, if the force is larger than the predetermined value, the operation member 100 moves from the driving position to the braking position.

The connecting member 105 is disposed in the second space 92 together with the bias member 102 and the projection member 103. The connecting member 105 comprises a joint member 106, an intermediate member 108, and a bias member 110. One end of the joint member 106 is fixed to the operation member 100. The opening 94 and the guide wall 96 are disposed below the joint member 106. The joint member 106 is switchable between a linear shape and a bent shape. The joint member 106 moves in conjunction with the movement of the operation member 100. As shown in FIG. 7, when the operation member 100 is in the driving position, the joint member 106 is in the linear shape. In the linear shape, the joint member 106 extends linearly. As shown in FIG. 8, when the operation member 100 is in the braking position, the joint member 106 is in the bent shape. In the bent shape, the joint member 106 is bent upward. By the joint member 106 switching between the linear shape and the bent shape, debris in the second space 92 is moved to the air passage 12b (i.e., the first space 12a) through the opening 94. Thereafter, the debris is discharged to the outside of the housing 4 through the air discharging hole 20 by the air flowing through the air passage 12b.

The intermediate member 108 is rotatably connected to another end of the joint member 106. As shown in FIG. 7, when the joint member 106 is in the linear shape, the intermediate member 108 is located in a rearward position. On the other hand, as shown in FIG. 8, when the joint member 106 is in the bent shape, the intermediate member 108 is located at a forward position. Apart of the intermediate member 108 is inserted in the bias member 110.

The bias member 110 is a coil spring. The bias member 110 biases the intermediate member 108 forward against the housing body 12. As shown in FIG. 7, even when a compression force of the bias member 110 acts on the intermediate member 108 in the state where the operation member 100 is in the driving position and the joint member 106 is in the linear shape, the joint member 106 is maintained in the linear shape. However, when the chain saw 2 undergoes a kickback impact during a cutting operation, the joint member 106 is slightly bent. When this happens, the joint member 106 is switched from the linear shape to the bent shape by the compression force of the bias member 110, and the operation member 100 moves from the driving position to the braking position (see FIG. 8).

One end of the band shoe 114 is connected to the intermediate member 108. The band shoe 114 is disposed to surround the outer periphery of the brake drum 54. Another end of the band shoe 114 is fixed to the housing body 12. As shown in FIG. 8, when the operation member 100 moves from the driving position to the braking position, the intermediate member 108 moves to the forward position and the band shoe 114 shrinks its diameter to contact an outer peripheral surface of the brake drum 54. The frictional force between the band shoe 114 and the brake drum 54 interrupts the rotation of the brake drum 54. That is, the rotation of the sprocket 50 is interrupted. As a result, the rotation of the saw chain 8 is stopped. On the other hand, as shown in FIG. 7, when the operation member 100 moves from the braking position to the driving position, the intermediate member 108 moves to the rearward position and the band shoe 114 expands its diameter to separate away from the outer peripheral surface of the brake drum 54. In this case, the rotation of the brake drum 54 is not interrupted. That is, the rotation of the sprocket 50 is not interrupted. Therefore, the saw chain 8 can rotate.

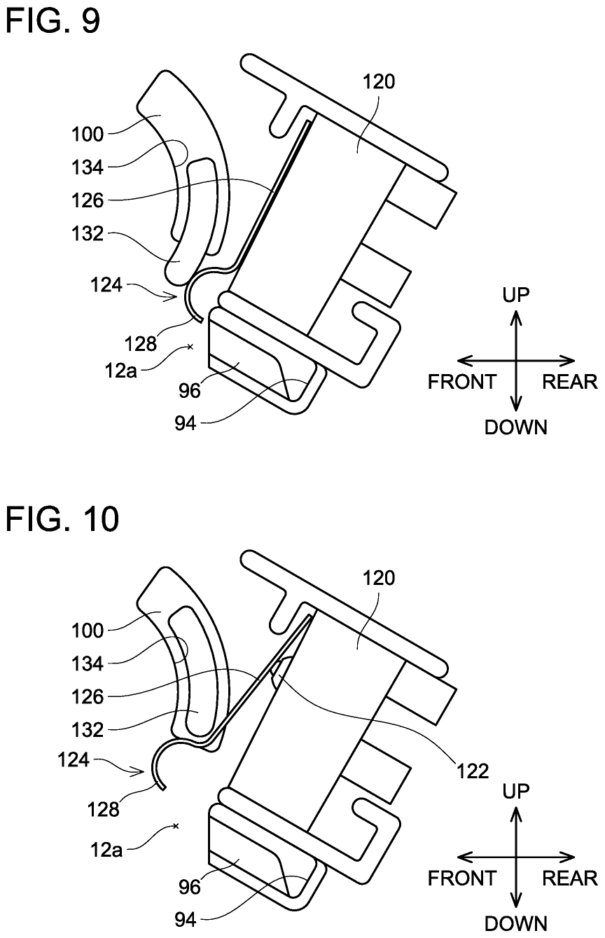

As shown in FIGS. 9 and 10, the chain saw 2 further comprises a switch member 120 and a plate member 124. FIGS. 9 and 10 view the front portion of the right side surface of the housing body 12 from the first space 12a side when the chain saw 2 is in the operating posture. As shown in FIG. 9, the switch member 120 and the plate member 124 are disposed in the first space 12a of the housing body 12. The switch member 120 and the plate member 124 are disposed opposite to the braking mechanism 104 with the right side surface of the housing body 12 interposed therebetween, although this is not shown. The switch member 120 includes a switch 122. While the switch 122 is pressed, current supply to the motor 34 is allowed. Therefore, when the trigger switch 26 (see FIG. 1) is pressed, the motor 34 is driven to rotate the saw chain 8. While the switch 122 is not pressed, the current supply to the motor 34 is prohibited. Therefore, in this case, even when the trigger switch 26 (see FIG. 1) is pressed, the motor 34 is not driven and thus the saw chain 8 is not rotated.

The plate member 124 comprises a linear portion 126 and a curved portion 128. The linear portion 126 extends linearly. The curved portion 128 is curved in a semicircular shape.

The chain saw 2 further comprises a pressing member 132. The pressing member 132 is integrally formed with the operation member 100. The pressing member 132 is inserted in an insertion hole 134 formed in the right side surface of the housing body 12 and extends to the first space 12a. The insertion hole 134 is closed by the operation member 100 on the second space 92 side. The pressing member 132 moves in conjunction with the movement of the operation member 100. As shown in FIG. 9, when the operation member 100 is in the driving position, the pressing member 132 is in contact with the curved portion 128 and is pressing the linear portion 126 toward the switch member 120. In this state, the switch 122 is pressed. As shown in FIG. 10, when the operation member 100 is in the braking position, the pressing member 132 is not in contact with the plate member 124, thus is separated therefrom. In this state, the linear portion 126 is separated from the switch 122. That is, the switch 122 is not pressed.

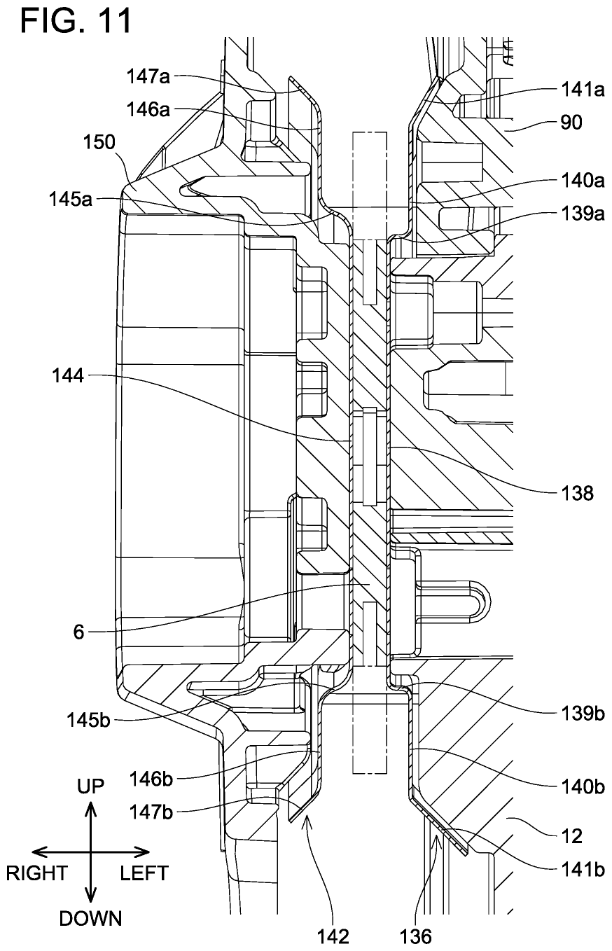

As shown in FIG. 11, the housing 4 further comprises an inner plate 136, an outer plate 142, and a sprocket cover 150. The inner plate 136 and the outer plate 142 interpose the guide bar 6 therebetween and are fixed to the right side surface of the housing body 12.

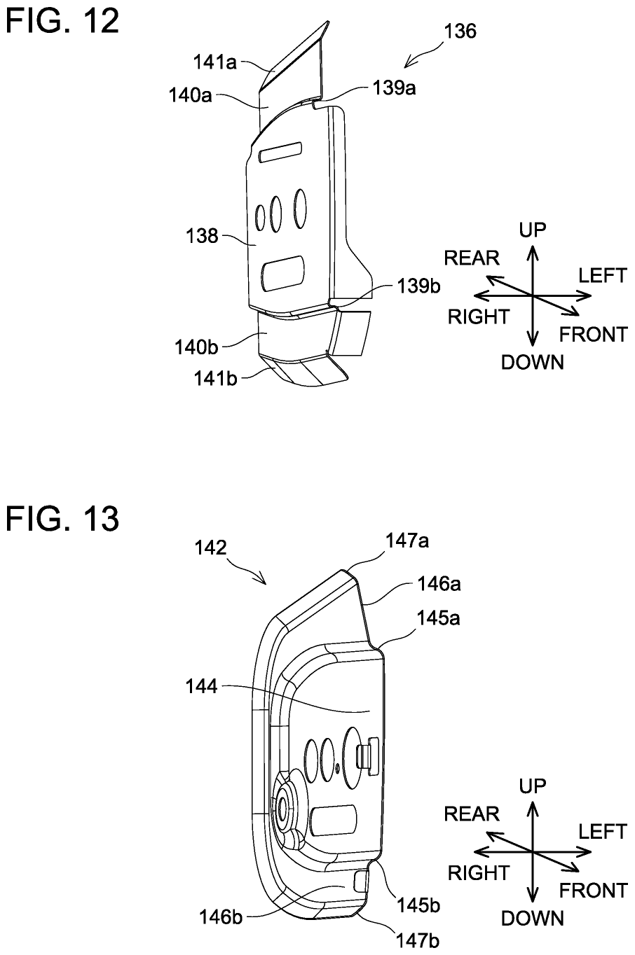

As shown in FIG. 12, the inner plate 136 comprises a first planar portion 138, first bent portions 139a and 139b, second planar portions 140a and 140b, and second bent portions 141a and 141b. The first planar portion 138 extends in the up-down direction. The first bent portions 139a and 139b are connected to end portions of the first planar portion 138 in the up-down direction, respectively, and are bent leftward. The second planar portions 140a and 140b are connected to the first bent portions 139a and 139b, respectively, and extend in the up-down direction. The second bent portion 141a is connected to an upper end portion of the second planar portion 140a, and is bent in an upper left direction. The second bent portion 141b is connected to a lower end portion of the second planar portion 140b, and is bent in a lower left direction.

As shown in FIG. 13, the outer plate 142 comprises a first planar portion 144, first bent portions 145a and 145b, second planar portions 146a and 146b, and second bent portions 147a and 147b. The first planar portion 144 extends in the up-down direction. The first bent portions 145a and 145b are connected to end portions of the first planar portion 144 in the up-down direction, respectively, and are bent rightward. The second planar portions 146a and 146b are connected to the first bent portions 145a and 145b, respectively, and extend in the up-down direction. The second bent portion 147a is connected to an upper end portion of the second planar portion 146a and is bent in an upper right direction. The second bent portion 147b is connected to a lower end portion of the second planar portion 146b and is bent in a lower right direction.

As shown in FIG. 11, the guide bar 6 is disposed between the first planar portion 138 of the inner plate 136 and the first planar portion 144 of the outer plate 142. The width between the first planar portion 138 of the inner plate 136 and the first planar portion 144 of the outer plate 142 is equal to the width of the guide bar 6 in its thickness direction. The width between the second planar portion 140a of the inner plate 136 and the second planar portion 146a of the outer plate 142 is equal to the width between the second planar portion 140b of the inner plate 136 and the second planar portion 146b of the outer plate 142, and is larger than the width between the first planar portion 138 of the inner plate 136 and the first planar portion 144 of the outer plate 142. While the saw chain 8 rotates, the saw chain 8 passes between the second planar portion 140a of the inner plate 136 and the second planar portion 146a of the outer plate 142 as well as between the second planar portion 140b of the inner plate 136 and the second planar portion 146b of the outer plate 142. In FIG. 11, the area where the saw chain 8 passes is depicted by a dash-dotted line. Debris adhering to the saw chain 8 when the chain saw 2 cuts an object falls off from the saw chain 8 between the second planar portion 140a of the inner plate 136 and the second planar portion 146a of the outer plate 142 and between the second planar portion 140b of the inner plate 136 and the second planar portion 146b of the outer plate 142.

The sprocket cover 150 covers the sprocket 50, the inner plate 136, and the outer plate 142. The sprocket cover 150 is fixed to the right side surface of the housing body 12.

In the chain saw 2 of the present embodiment, the oil is supplied into the oil tank 60 in the state where the chain saw 2 is placed on the plane P such that the oil filler part 64 of the oil tank 60 faces upward. During the oil supply, the oil may be spilled near the oil filler part 64. In the chain saw 2 of the present embodiment, the motor 34 and the oil tank 60 are disposed in the first space 12a of the housing body 12 of the housing 4. The oil filler part 64 of the oil tank 60 is inserted in the through hole 76 and is exposed to the outside of the housing body 12 of the housing 4. The suppression structure 66 of the oil tank 60 is disposed on the motor 34 side relative to the oil filler part 64 when the chain saw 2 is placed on the plane P such that the oil filler part 64 faces upward, and suppresses the oil on the first outer surface 62a of the oil tank body 62 facing upward from flowing to the motor 34. In the above-described configuration, when the oil is spilled near the oil filler part 64 toward the motor 34, the suppression structure 66 suppresses the oil from flowing to the motor 34. Therefore, it is possible to suppress the oil from flowing on the outer surface of the oil tank body 62 that is located on the motor 34 side in the first space 12a.

Moreover, when the chain saw 2 is placed on the plane P such that the oil filler part 64 faces upward, the first outer surface 62a is inclined downward in the direction away from the motor 34. In the above-described configuration, when the oil is spilled near the oil filler part 64, the spilled oil flows on the first outer surface 62a in the direction away from the motor 34. Therefore, it is possible to suppress the oil from flowing on the outer surface of the oil tank body 62 located on the motor 34 side in the first space 12a.

Further, the guide structure 70 is connected to the suppression structure 66. The guide structure 70 guides the oil in the direction away from the motor 34. In the above-described configuration, the oil held back by the suppression structure 66 flows in the direction away from the motor 34 along the guide structure 70. Therefore, it is possible to suppress the oil from flowing on the outer surface of the oil tank body 62 located on the motor 34 side in the first space 12a.

Moreover, when the chain saw 2 is in the operating posture, the oil spilled near the oil filler part 64 flows downward along the outer surface of the oil tank body 62, and then drops from the oil tank body 62. In the chain saw 2 of the present embodiment, when the chain saw 2 is in the operating posture, the receiver part 82 is disposed below the oil tank 60, and at least partially overlaps the oil tank 60 when the chain saw 2 is viewed from above. In the above-described configuration, the oil drops from the oil tank 60 into the receiver part 82. Therefore, it is possible to suppress the oil from dropping out of the receiver part 82.

The communication hole 84 communicates the first space 12a to the outside of the housing body 12 of the housing 4. The communication hole 84 is disposed in the receiver part 82. In the above-described configuration, when the chain saw 2 is in the operating posture, the oil dropped into the receiver part 82 is discharged to the outside of the housing body 12 through the communication hole 84. Therefore, accumulation of the oil in the first space 12a can be suppressed.

Further, the oil tank body 62 defines a part of the air passage 12b. Air flows between the oil tank body 62 and the motor 34 along the outer surface of the oil tank body 62. In the above-described configuration, even when debris adheres to the outer surface of the oil tank body 62, the debris can be removed from the outer surface of the oil tank body 62 by the air flowing along the outer surface of the oil tank body 62.

Moreover, in the state where the oil tank 60 is disposed in the first space 12a, the suppression structure 66 is in contact with the peripheral wall 78 which extends along the periphery of the through hole 76 of the housing body 12. The peripheral wall 78 is disposed in the groove 68 formed between the oil filler part 64 and the suppression structure 66. In the above-described configuration, when the oil is spilled vigorously near the oil filler part 64 during the oil supply to the oil tank 60, the peripheral wall 78 reduces the momentum of the flow of the oil. Therefore, as compared with a case where the chain saw 2 does not include the peripheral wall 78, the chain saw 2 of the present embodiment can suppress the oil from flowing to the motor 34 side over the suppression structure 66.

During a cutting operation where the chain saw 2 of the present embodiment cuts an object, debris from the object may enter the second space 92 through the through hole 98 and accumulate in the second space 92. In the chain saw 2 of the present embodiment, the operation member 100 and the braking mechanism 104 are both disposed in the second space 92. The operation member 100 moves between the braking position and the driving position. The joint member 106 of the connecting member 105 of the braking mechanism 104 moves in the second space 92 in conjunction with the operation member 100. The opening 94 of the housing body 12 of the housing 4 communicates the first space 12a to the second space 92. In the above-described configuration, the debris in the second space 92 is pushed and discharged from the second space 92 through the opening 94 by the joint member 106 moving in conjunction with the operation member 100. Therefore, it is possible to suppress trouble in the operation of the braking mechanism 104 caused by the debris accumulation in the second space 92.

Moreover, when the chain saw 2 is in the operating posture, the opening 94 is disposed below the braking mechanism 104. In the above-described configuration, when the chain saw 2 is in the operating posture, the debris in the second space 92 accumulates near the opening 94 by gravity. Therefore, when the joint member 106 moves, the debris can be easily discharged from the second space 92 to the first space 12a through the opening 94.

Further, the joint member 106 is in the linear shape when the operation member 100 is in the driving position, while it is in the bent shape when the operation member 100 is in the braking position. The bias member 110 exerts a compression force onto the joint member 106 by biasing the intermediate member 108 forward. In the above configuration, the joint member 106 is maintained in the linear shape, even when the compression force of the bias member 110 acts on the intermediate member 108 in the state where the joint member 106 is in the linear shape. However, when the chain saw 2 undergoes a kickback impact in a cutting process, the joint member 106 is slightly bent and the compression force applied by the bias member 110 causes the joint member 106 to switch to the bent shape from the linear shape. In the above-described configuration, the braking mechanism 104 can be automatically activated when the kickback occurs. Therefore, the operator's safety can be improved.

Furthermore, the band shoe 114 is disposed to surround the outer periphery of the brake drum 54. When the operation member 100 moves from the driving position to the braking position, the intermediate member 108 moves to the forward position, and the band shoe 114 shrinks its diameter to contact the outer peripheral surface of the brake drum 54. This interrupts the rotation of the brake drum 54. On the other hand, when the operation member 100 moves from the braking position to the driving position, the intermediate member 108 moves to the rearward position, and the band shoe 114 expands its diameter to separate away from the outer peripheral surface of the brake drum 54. This does not interrupt the rotation of the brake drum 54. In the above-described configuration, the braking mechanism 104 can be realized by the simple structure of the band shoe 114.

Moreover, when the chain saw 2 is in the operating posture, the guide wall 96 extends along the lower edge of the opening 94. The guide wall 96 protrudes from the left side surface of the housing body 12. In the above-described configuration, the debris that has been moved to a vicinity of the opening 94 by the movement of the connecting member 105 moves along the guide wall 96 to the opening 94. Therefore, the debris can be efficiently moved to the opening 94.

The chain saw 2 according to one embodiment may comprise an engine, instead of the motor 34, as a prime mover that rotates the sprocket 50. In this case, the shaft 44 connected to the sprocket 50 may be rotated by the engine.

In the chain saw 2 according to one embodiment may be a rear-handle chain saw.

In the chain saw 2 according to one embodiment, the opening 94 may be disposed on an extension of the joint member 106 in its bending direction.

In the chain saw 2 according to one embodiment, the joint member 106 may move in the linear shape without bending when the operation member 100 moves between the driving position and the braking position.

In the chain saw 2 according to one embodiment, the suppression structure 66 may be a groove that is recessed inward from the first outer surface 62a of the oil tank body 62.

In the chain saw 2 according to one embodiment, the space in which the oil is stored may be defined only by the oil tank body 62.

The chain saw 2 according to one embodiment may not include the switch member 120.

What is claimed is:

1. A chain saw comprising:
a prime mover configured to rotate a saw chain;
a braking mechanism configured to stop rotation of the saw chain;
a housing including a first space in which the prime mover is disposed and a second space in which the braking mechanism is disposed; and
an operation member configured to operate the braking mechanism,
wherein
the housing includes an opening communicating the first space to the second space and a through hole communicating the second space to outside of the housing,
the operation member is disposed over the second space and the outside of the housing through the through hole,
the operation member is movable between a braking position where the operation member causes the braking mechanism to interrupt the rotation of the saw chain and a driving position where the operation member causes the braking mechanism not to interrupt the rotation of the saw chain, and
the braking mechanism comprises a connecting member configured to move in the second space in conjunction with movement of the operation member.

2. The chain saw according to claim 1, wherein when the chain saw is in an operating posture, the opening is disposed below the connecting member in a vertical direction.

3. The chain saw according to claim 1, wherein the connecting member comprises:
a joint member, wherein the joint member is in a linear shape when the operation member is in the driving position and the joint member is in a bent shape when the operation member is in the braking position; and
a bias member configured to apply a compression force to the joint member.

4. The chain saw according to claim 1, further comprising:
a shaft configured to transmit rotation of the prime mover to the saw chain; and
a brake drum fixed to the shaft,
wherein
the braking mechanism further comprises a band shoe disposed to surround an outer periphery of the brake drum, and
the band shoe is configured to shrink a diameter of the band shoe to interrupt rotation of the brake drum when the operation member moves from the driving position to the braking position and is configured to expand the diameter of the band shoe not to interrupt the rotation of the brake drum when the operation member moves from the braking position to the driving position.

5. A chain saw comprising:
a motor configured to rotate a saw chain;
an oil tank storing oil to be supplied to the saw chain; and
a housing including a first space in which the motor and the oil tank are disposed;
wherein
the housing includes a through hole communicating the first space to outside of the housing, and
the oil tank comprises:
an oil tank body storing the oil therein;
an oil filler part that is exposed to the outside of the housing through the through hole and through which the oil is supplied into the oil tank body; and
a suppression structure disposed on a motor side relative to the oil filler part, wherein when the chain saw is placed on a plane such that the oil filler part faces upward, the suppression structure suppresses the oil on a first outer surface of the oil tank body that faces upward from flowing to the motor side.

6. The chain saw according to claim 5, wherein when the chain saw is placed on the plane such that the oil filler part faces upward, the first outer surface of the oil tank body is inclined downward in a direction away from the motor.

7. The chain saw according to claim 5, wherein the oil tank further comprises a guide structure that is connected to the suppression structure and is configured to guide the oil in a direction away from the motor when the chain saw is placed on the plane such that the oil filler part faces upward.

8. The chain saw according to claim 5, wherein
a receiver part is disposed on a first-space-side surface of the housing, the receiver part being configured to receive the oil dropped from the oil tank, and
the receiver part is disposed below the oil tank when the chain saw is in an operating posture and at least partially overlaps the oil tank when the chain saw is viewed from above.

9. The chain saw according to claim 8, wherein
a communication hole is disposed in the housing, the communication hole communicating the first space to the outside of the housing,
the communication hole is disposed at the receiver part.

10. The chain saw according to claim 5, wherein
the first space comprises an air passage through which air for cooling the motor flows, and
the oil tank defines a part of the air passage.
